(19) United States
(12) Patent Application Publication
(10) Pub. No.: US 2012/0009501 A1
(43) Pub. Date: Jan. 12, 2012

(54) METHODS OF MANUFACTURING PROTON CONDUCTIVE SOLID OXIDE FUEL CELL AND PROTON CONDUCTIVE SOLID OXIDE FUEL CELLS MANUFACTURED BY USING THE METHODS

(75) Inventors: Sang-kyun Kang, Seoul (KR); Young-beom Kim, Stanford, CA (US); Jin-su Ha, Seoul (KR); Friedrich B. Prinz, Woodside, CA (US); Turgut M. Gür, Palo Alto, CA (US)

(73) Assignees: The Board of Trustees of The Leland Stanford JR. University, Palo Alto, CA (US); Samsung Electronics Co., Ltd, Suwon-si (KR)

(21) Appl. No.: 13/008,298

(22) Filed: Jan. 18, 2011

(30) Foreign Application Priority Data
Jul. 9, 2010 (KR) 10-2010-0066562

(51) Int. Cl. H01M 8/10; B82Y 99/00

(52) U.S. Cl. 429/483; 29/623.5; 429/482; 977/755

(57) ABSTRACT

A method of manufacturing a proton conductive solid oxide fuel cell, the method including: forming a metallic mask layer having nanoholes on a first surface of a substrate; selectively etching the first surface of the substrate using the metallic mask layer; depositing a first membrane electrode assembly (MEA) member on the etched first surface of the substrate; etching an opposing second surface of the substrate; and forming second and third MEA members on the first MEA member.

### STATEMENT OF GOVERNMENT SUPPORT

This invention was made with Government support under contract N00014-07-10758 awarded by the Office of Naval Research. The Government has certain rights in this invention.

### CROSS-REFERENCE TO RELATED APPLICATION

This application claims the benefit of Korean Patent Application No. 10-2010-0066562, filed on Jul. 9, 2010, in the Korean Intellectual Property Office, the disclosure of which is incorporated herein, by reference.

### BACKGROUND

1. Field

The present disclosure relates to methods of manufacturing a proton conductive solid oxide fuel cell, and proton conductive solid oxide fuel cells manufactured using the methods.

2. Description of the Related Art

Fuel cells, which are one of attractive alternative energy sources, can be categorized into polymer electrolyte membrane fuel cells (PEMFCs), phosphoric acid fuel cells (PAFCs), molten carbonate fuel cells (MCFCs), and solid oxide fuel cells (SOFCs), according to a kind of electrolyte used therein.

Among SOFCs, proton conductive solid oxide fuel cells use a proton-conducting solid oxide as an electrolyte. Proton conductive solid oxide fuel cells have high efficiency and high durability, use various kinds of fuels, and are manufactured at low costs.

An output-power density of proton conductive solid oxide fuel cell is proportional to the area density of the proton conductive solid oxide fuel cell. The area density is obtained by dividing a reaction area by an apparent area (for example, a horizontal surface area of a fuel cell). Accordingly, in order to increase the reaction area, a three-dimensional uneven structure may be formed in a direction perpendicular to the plane of a membrane electrode assembly (MBA).

The area density of an MEA having the three-dimensional uneven structure is almost proportional to an aspect ratio of the uneven structure (for example, a ratio of height to width of the uneven structure). An increase in the aspect ratio of the uneven structure, resulting from an increase of the height of the uneven structure, leads to an increase in an electron pathway, and thus, there is an increase in resistance. Accordingly, there is a need to develop a method of reducing the size of the 3-dimensional uneven structure.

### SUMMARY

Provided are methods of manufacturing a proton conductive solid oxide fuel cell.

Provided are proton conductive solid oxide fuel cells manufactured using the methods.

Additional aspects will be set forth in part in the description which follows and, in part, will be apparent from the description, or may be learned by practice of the presented embodiments.

According to an aspect of the present invention, a method of manufacturing a proton conductive solid oxide fuel cell includes: forming a metallic mask layer having nanoholes, on a first surface of a substrate; selectively etching the first surface of the substrate, using the metallic mask layer as a mask, to form uneven structures on the first surface of the substrate; depositing a first membrane electrode assembly (MEA) member on the uneven first surface of the substrate; and etching an opposing second surface of the substrate.

According to another aspect of the present invention, provided is a proton conductive solid oxide fuel cell manufactured using the method described above.

### BRIEF DESCRIPTION OF THE DRAWINGS

The patent or application file contains at least one drawing executed in color. Copies of this patent or patent application publication with color drawing(s) will be provided by the U.S. Patent and Trademark Office upon request and payment of the necessary fee. These and/or other aspects will become apparent and more readily appreciated from the following description of the embodiments, taken in conjunction with the accompanying drawings of which:

FIG. 1 shows diagrams to explain a method of manufacturing a proton conductive solid oxide fuel cell, according to an embodiment of the present invention;

FIG. 2 shows diagrams to explain a method of manufacturing a proton conductive solid oxide fuel cell, according to another embodiment of the present invention;

FIG. 3 shows diagrams to explain a method of manufacturing a proton conductive solid oxide fuel cell, according to another embodiment of the present invention;

FIG. 4A is a scanning electron microscope (SEM) image of nanoparticles aligned on a substrate of Example 1;

FIG. 4B is an SEM image of nanoparticles etched in Example 1;

FIG. 4C is an SEM image of an Ag mask including nanoholes formed by removing the nanoparticles in Example 1;

FIG. 4D is an SEM image of a substrate having an uneven surface including nanorods, in Example 1;

FIG. 5A is an SEM image of a surface of the substrate in Example 2 that is etched in a thickness direction;

FIG. 5B is an SEM image of an uneven structured freestanding thin film of a silicon nitride protection layer prepared according to Example 2;

FIG. 5C is an SEM image of an uneven structured freestanding thin film of a membrane electrode assembly (MEA) manufactured according to Example 2;

FIG. 6 is an SEM image of a an uneven structure formed in a patterned region of a substrate in Example 3; and

FIG. 7 shows performance evaluation results of MEA-including fuel cells manufactured according to Example 2 and Comparative Example 1.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

A method of manufacturing a proton conductive solid oxide fuel cell, according to an embodiment of the present invention, includes forming a metallic mask layer having nanoholes on a first surface of a substrate; selectively etching a portion of the first surface of substrate, using the metallic mask layer, to form an uneven structure on the first surface on the substrate; depositing a first membrane electrode assembly (MEA) member on the uneven first surface of the substrate; and etching an opposing second surface of the substrate.

MEA members may include a proton-conducting solid oxide electrolyte membrane, a cathode, and an anode. The metallic mask layer may be formed by arranging nanoparticles on the surface of the substrate; depositing a metal layer on the surface of the substrate, between the aligned nanoparticles; and removing the nanoparticles to form the metallic mask layer. The nanoholes of the mask layer may have a regular arrangement.

The metal layer is formed on only portions of the substrate that exposed between the nanoparticles. The metal layer may be deposited according to any method that is known in the art. For example, the metal layer deposition method may be sputtering or physical vapor deposition (PVD). The metal of the metal layer may be gold (Au), silver (Ag), or aluminum (Al), but is not limited thereto. For example, the metal may be any kind of metal that is used in the art.

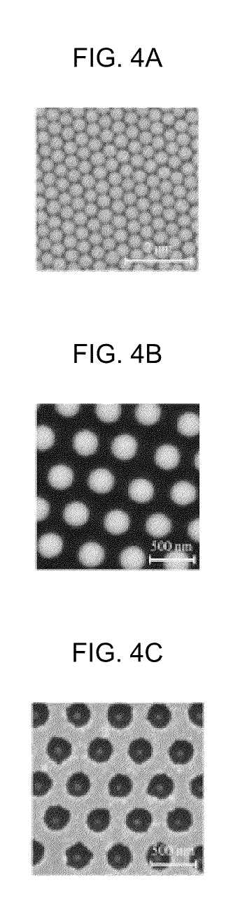

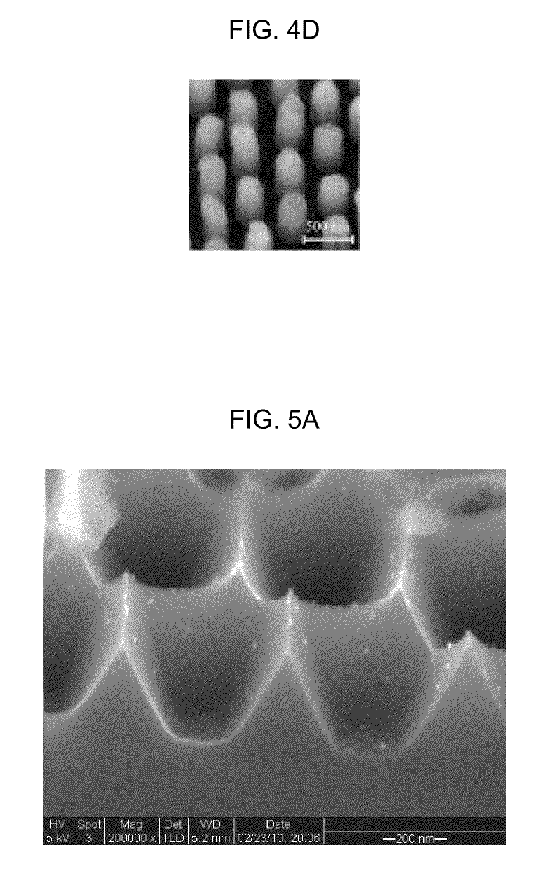

The nanoparticles may be removed from the metal layer using ultrasonic waves. The removal of the nanoparticles, as shown in FIG. 4C, results in the formation of the metallic mask layer having regularly arranged nanoholes. The diameters of the nanoholes may be equal to or smaller than the diameters of the nanoparticles.

The preparing of the nanoparticles may include aligning the nanoparticles on the substrate, and etching the nanoparticles to separate the nanoparticles from each other. For example, as illustrated in FIG. 4A, the nanoparticles may be aligned in contact with each other, at a high density, so as to form a monolayer on the surface of the substrate, by using a Langmuir-Blodgett method (hereinafter, referred to as an LB method). The method of aligning the nanoparticles is not limited to the LB method and may be any method that is used in the art. Then, as illustrated in FIG. 4B, the monolayer is etched to separate the nanoparticles. That is, the nanoparticles are reduced in size by etching, and thus, the nanoparticles are separated from each other.

The sizes (average diameters) of the etched nanoparticles may be less than 1 μm. For example, the average diameter the etched nanoparticles may be in a range of about 10 to about 990 nm, about 100 to about 900 nm, or about 150 to about 500 nm.

The substrate may be a silicon substrate, and the nanoparticles may be silicon nanoparticles, but these elements are not limited thereto. For example, the substrate and the nanoparticles may each be formed of any material that is used in the art.

The etching of the substrate may include selectively etching a surface of the substrate, using the metal layer as a mask, and then removing the metal layer. As a result, the etched surface of the substrate has an uneven structure.

During the etching of the substrate, the portions of the substrate that are exposed by the nanoholes may not be etched, while the portions of the substrate covered by the metal layer are etched. In particular, the etching may be a metal assisted etching, through which portions of the substrate in contact with the metal layer are etched, in a thickness direction of the substrate. In other words, the metal layer acts as a catalyst of the etching reaction, and the shape of the metal layer is maintained.

For example, when the substrate is a silicon substrate and is dipped in an aqueous solution containing hydrogen peroxide and hydrofluoric acid, a metal assisted etching reaction represented by Reaction Scheme 1 below is performed, to selectively etch the portion of the silicon substrate under the metal layer, while the shape of the metal layer is maintained. The substrate may be etched to a depth that is appropriately selected, according to etching conditions.

Si+H₂O₂+6HF→2H₂O+H₂SiF₆+H₂

As illustrated in FIG. 4D, the un-etched portions of the substrate, which are the portions exposed through the nanoholes, may constitute protruding nanorods. The metal layer is removed after the etching, to prepare the substrate having a first surface with an uneven structure. The metal layer may be removed by, for example, immersing the substrate in aquaregia (a solution including hydrochloric acid and nitric acid, in a mixture ratio of 3:1), but the removing method is not limited thereto. For example, the removing method may be any method that is used in the art.

Accordingly, the substrate has the uneven surface, and the uneven surface may include the nanorods in a regular arrangement, that extend away from the substrate. The diameters of the nanorods may be equal to or smaller than the diameters of the nanoholes.

Herein, an MEA member formed on the first surface of the substrate may be a proton-conductive solid oxide electrolyte, a cathode, or an electrode. These MEA members can be sequentially deposited, so as to form an MEA, including the solid oxide electrolyte disposed between the anode and the cathode.

The etching of the opposing (second) surface of the substrate includes forming a protection layer on the second surface of the substrate; exposing a portion of the second surface, by removing a portion of the protection layer; partially etching the exposed portion of the second surface; and then completely etching the exposed second surface of the substrate, thereby forming a freestanding thin film, including the at least one of the MEA members.

The second protection layer may be formed on the second surface of the substrate. The second protection layer may be an etching prevention layer. The protection layer may be a silicon nitride layer, but is not limited thereto. For example, the protection layer may be any protection layer that is used in the art. Subsequently, a portion of the protection layer is removed by, for example, lithography, so as to expose a portion of the second surface of the substrate.

In the etching of the exposed second surface of the substrate, the partial etching may be a wet etching. For example, the partial etching may be performed with a KOH solution. If the second surface is completely etched by wet etching, the first MEA member may be damaged. Thus, the wet etching is stopped, while there is still some of the substrate remains on the first MEA member.

The remaining second surface is completely removed by dry etching, to form the freestanding thin film MEA member. The dry etching may be performed using XeF₂, but is not limited thereto. For example, the dry etching may be any method that is used in the art.

The freestanding thin film MEA member may include nanotubes that are regularly arranged and extend away from the substrate. The nanotubes may be a replica of the nanorods formed on the first surface of the substrate. The nanotubes may extend perpendicularly from the substrate. In each of the nanotubes, one end may be sealed.

Diameters of the nanotubes may be less than 1 μm. For example, the diameters of the nanotubes may be in the range of about 10 to about 990 nm, about 100 to about 900 nm, or about 250 to about 750 nm.

Aspect ratios (height to diameter) of the nanotubes may be 2:1 or more. For example, the aspect ratios may range from about 2:1 to 100:1, about 5:1 to 100:1, or about 10:1 to 100:1.

The method may further include forming other MEA members on the freestanding MEM member. For example, a cathode and an anode may be additionally and respectively formed on surfaces of a proton-conductive solid oxide electrolyte freestanding thin film having an uneven structure, thereby forming an MEA.

An example of the method of manufacturing a proton conductive solid oxide fuel cell may include: continuously aligning silicon nanoparticles on a substrate; spacing the silicon nanoparticles by etching the silicon nanoparticles; depositing a metal layer between the silicon nanoparticles; removing the silicon nanoparticles, to form a metallic mask layer including aligned nanoholes, on the surface of the silicon substrate; selectively etching a first surface of the substrate, on which the metallic mask layer is formed, in a thickness direction of the silicon substrate; removing the metallic mask layer from the uneven surface (including silicon nanorods) of the silicon substrate; depositing a proton-conductive solid oxide electrolyte layer on the first surface; forming the silicon nitride layer on the opposing second surface of the silicon substrate; etching a portion of the silicon nitride layer to expose a portion of the second surface; partly etching the exposed second surface; completely etching the exposed second surface, to form a freestanding proton-conductive solid oxide electrolyte thin film having an uneven structure; and forming a cathode on a surface of the thin film and an anode on an opposing surface of the thin film.

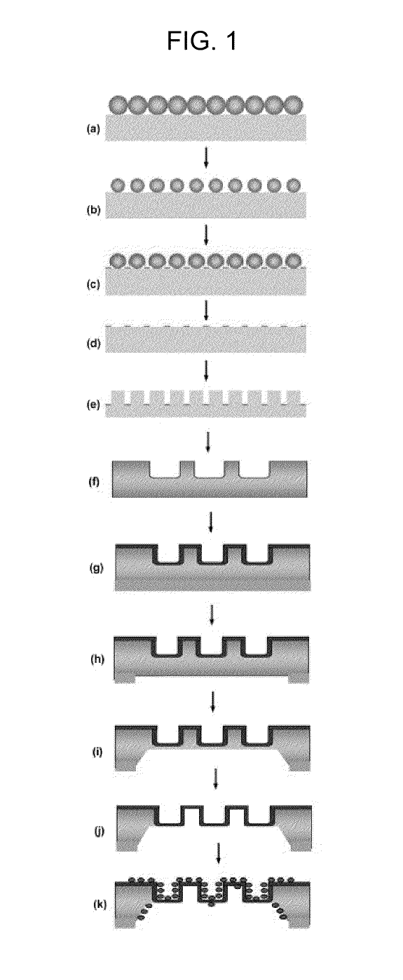

The method of manufacturing a proton conductive solid oxide fuel cell will now be described in detail by referring to FIG. 1. First, silicon nanoparticles are aligned at a high density, on a silicon substrate, using an LB method, to form a continuous monolayer, in which neighboring silicon nanoparticles contact each other (a). Then, the silicon nanoparticles are separated from each other, by plasma etching (b). Ag is deposited between the silicon nanoparticles by PVD, to form an Ag layer (c).

Then, the silicon nanoparticles are removed using ultrasonic waves, to form an Ag mask layer including regularly arranged nanoholes, on the silicon substrate (d). The resultant structure is immersed in a solution including hydrogen peroxide and hydrofluoric acid, so as to selectively etch a portion of the silicon substrate on which the Ag mask layer is formed (e). The resultant structure is immersed in aquaregia (a mixed solution including hydrochloric acid and nitric acid, in a mixture ratio of 3:1) to remove the Ag mask layer, so that the silicon substrate has an uneven first surface including silicon nanorods (f).

A proton-conductive solid oxide electrolyte thin film (first MEA member) is deposited on the first surface, and a silicon nitride layer is formed on an opposing second surface of the silicon substrate (g). A portion of the silicon nitride layer is etched by lithography, to expose a portion of the second surface (h). Then, the exposed second surface is partly etched with a KOH solution (i).

Then, the remaining exposed second surface is completely etched using, for example, XeF₂ dry etching, such that the silicon substrate is completely removed from the electrolyte thin film. As such, the resultant thin film is freestanding and has an uneven structure (j). In addition, a cathode and an anode (MEA members) may be respectively formed on surfaces of the freestanding thin film, to manufacture an MEA (k).

The above etching operations may be performed using isotropic etching or anisotropic etching. In addition, both isotropic etching and anisotropic etching may be simultaneously used. The isotropic etching may be etching using, for example, SF₆ gas. The anisotropic etching may be etching using, for example, a gas mixture including SF₆ and CHCIF₂. By appropriately controlling the isotropic etching and the anisotropic etching, an etching profile may be controlled.

According to another exemplary embodiment of the present invention, the method may be modified, such that a first protection layer is formed on the first surface of the substrate, rather than the first MEA member. Since this method is similar to the previous method, only the differences therebetween will be described in detail.

In particular, the first protection layer is deposited on the etched first surface of the substrate, and a second protection layer is formed on the second surface of the substrate. The first and second protection layers may be silicon nitride layers. A portion of the second protection layer is removed to expose a portion of the second surface.

In addition, when the first protection layer is formed on the substrate, during the etching of the first surface of the substrate, the portions of the first surface that are not coated by the metallic mask layer, and thus exposed, may be etched. The etching may be isotropic etching and/or anisotropic etching. The isotropic etching may be etching using, for example, SF₆ gas. The anisotropic etching may be etching using, for example, a mixed gas including SF₆ and CHCIF₂ gas. By appropriately controlling the isotropic etching and the anisotropic etching, an etching profile may be controlled.

The exposed second surface of the substrate is etched, such that the first protection layer is a freestanding thin film. The first MEA member is then formed on the first protection layer, and then the first protection layer is removed from the first MEA member.

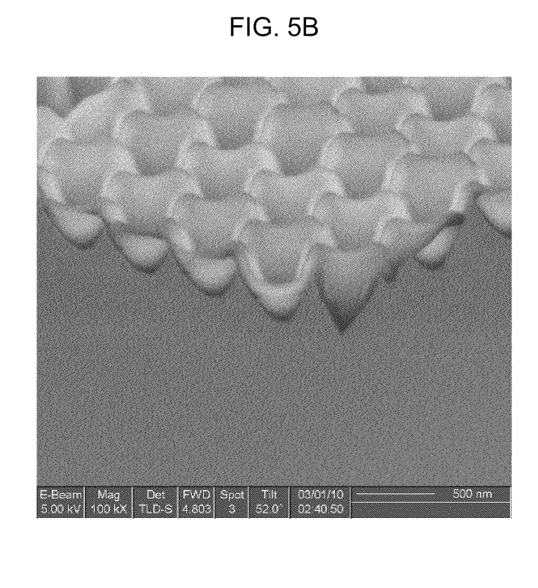

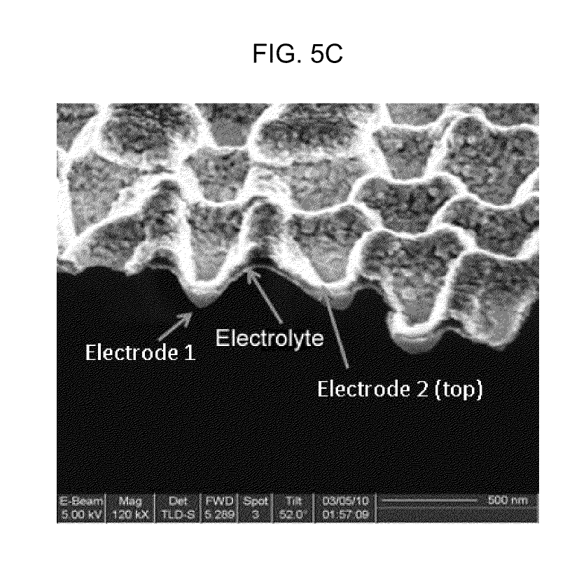

The etching of the second surface of the substrate allows for the formation of the freestanding protection layer having a corrugated structure, as shown in FIG. 5B. The first MEA member may be selected from the group consisting of a proton-conducting solid oxide electrolyte, a cathode, and an anode. For example, the first MEA member may be a proton-conducting solid oxide electrolyte.

The protection layer may be removed from the first MEA member. The resultant MEA member may include protrusions and depressions, so as to have a wrinkled, wave-shaped, or corrugated structure. For example, the protrusions and depressions may be tapered, so as to have wedge-shaped cross-sections.

A distance between adjacent summits of the protrusions may be 2 μm or less. For example, the distance may be in a range of about 10 to about 990 nm, about 100 to about 1900 nm, or about 250 to about 1000 nm.

A distance between a summit of one of the protrusions and the bottom of one of the depressions, in a thickness direction of the MEA, may be 2 μm or less. For example, the distance may be in a range of about 100 to about 1900 nm, or about 250 to about 1000 nm.

Other MEA members may be formed on the freestanding first MEA member. For example, a cathode and an anode may be formed on opposing surfaces of the proton-conductive solid oxide electrolyte first MEA member, thereby forming a MEA as shown in FIG. 5C.

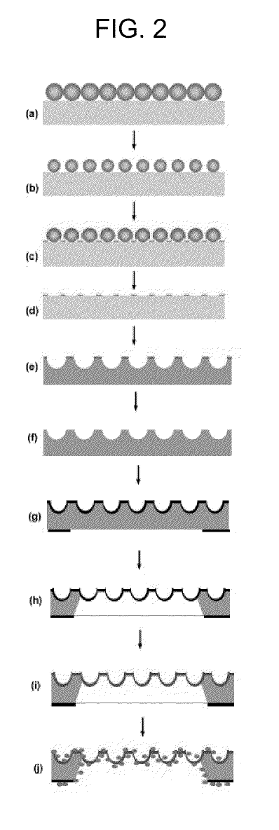

A method of manufacturing a proton conductive solid oxide fuel cell, according to another exemplary embodiment, will now be described in detail, by referring to FIG. 2. First, a continuous monolayer of silicon nanoparticles is formed on a first surface of a silicon substrate, using an LB method (a). Then, the silicon nanoparticles are separated from each other by plasma etching (b). Then, Al is deposited between the silicon nanoparticles by PVD, to form an Al layer (c).

The silicon nanoparticles are removed using ultrasonic waves, to form an Al mask layer including aligned nanoholes, on the silicon substrate (d). Then, portions of the silicon substrate exposed through the nanoholes are selectively etched, in a thickness direction of the silicon substrate, by one or both of isotropic etching and anisotropic etching (e).

The Al mask layer is removed. The resultant silicon substrate has an uneven first surface that includes tapered protrusions and depressions (f). Then, first and second silicon nitride layers (first and second protection layers) are respectively formed the first surface and an opposing second surface of the silicon substrate. A portion of the second silicon nitride layer is removed, to expose a portion of the second surface of the silicon substrate (g).

Then, the exposed second surface of the silicon substrate is etched with a KOH solution, to form a freestanding silicon nitride thin film (h). Then, a proton-conductive solid oxide electrolyte layer is formed on the silicon nitride thin film. The thin film is then removed, to form a freestanding proton-conductive solid oxide electrolyte thin film having an uneven structure (the tapered protrusions and depressions) (i). Then, a cathode and an anode are respectively formed on opposing surfaces of the electrolyte thin film to form an MEA (j).

The method may further include, before preparing the nanoparticles, forming a photoresist pattern on the first surface of the substrate, and forming a protection layer with a pattern corresponding to the pattern of the photoresist layer, on the opposing second surface of the substrate. The photoresist layer may be removed prior to, or at the same time as, the removing of the nanoparticles.

That is, the nanoparticles are aligned on the patterned photoresist layer, the metal layer is formed therebetween, the patterned photoresist layer is removed (the nanoparticles aligned on the photoresist layer are also simultaneously removed), and then the remaining nanoparticles on the substrate are removed. Alternatively, the nanoparticles present on the patterned photoresist layer and the nanoparticles present on the substrate may be simultaneously removed.

The selective etching of the first surface of the substrate may include selectively etching the portions of the first surface that contact the metal layer. That is, during the selective etching, portions of the first surface that are not covered by the metal layer, such as portions of the substrate where the photoresist layer is removed, or portions of the substrate exposed through nanoholes of the metal layer, may be un-etched. The selective etching may be a metal assisted etching, as used in the previous example.

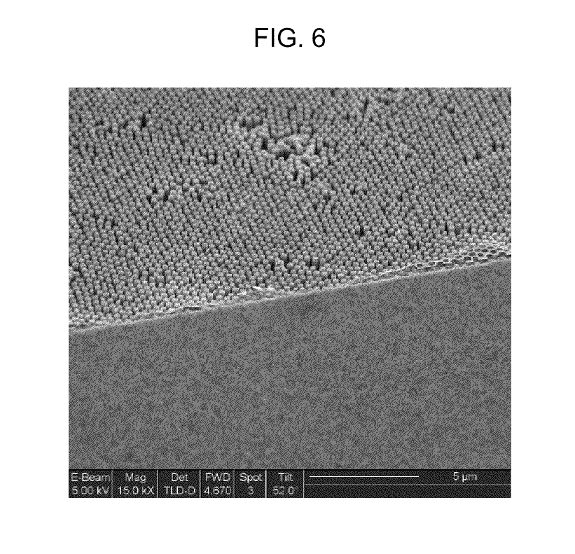

As shown in FIG. 6, the first surface of the substrate has an uneven structure, in areas where the photoresist layer is not formed. That is, the first surface of the substrate may include a pattern of even and uneven surface portions. When the MEA member is deposited on an uneven portion of the substrate, the overall shape of the MEA member may not be the same as the shape of the uneven portion. Instead, a first surface of the MEA member may correspond to the shape of the uneven portion, while an opposing second surface of the MEA member may be generally flat. Accordingly, the first surface of the MEA member has nanorods that protrude into the uneven portion of the substrate.

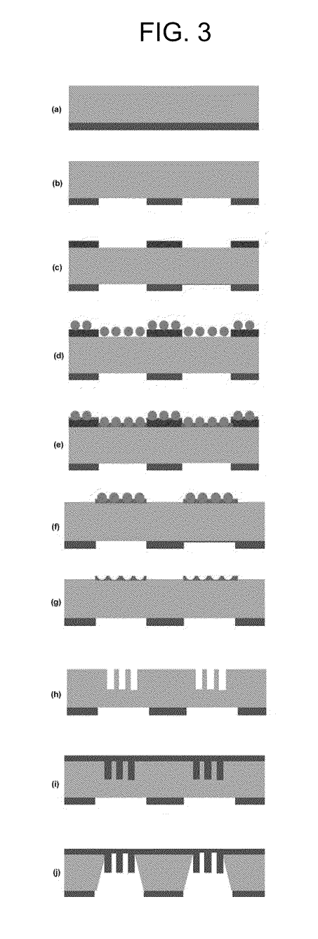

With regard to the forming of the freestanding first MEA member (operation j), one surface of the first MEA member may have an uneven structure (FIG. 3), while the opposing second surface is flat. The first surface may include nanorods, which protrude in the thickness direction of the MEA member.

Since portions of the first surface of the substrate where the first protection layer is formed are not etched, portions of the surface of the MEA member are flat. That is, the first surface of the freestanding MEA member layer may be patterned with flat and uneven portions.

The method may further include forming other MEA members on the flat second surface of the first MEA member. That is, when the first MEA member is an electrode, a proton-conductive solid oxide electrolyte and/or an electrode may be additionally formed on the second surface of the first MEA member, thereby forming an MEA.

Another method of manufacturing a proton conductive solid oxide fuel cell, according to aspects of the present disclosure, will now be described by referring to FIG. 3. First, a silicon nitride layer (first protection layer) is formed on a first surface of a silicon substrate (a). Then, the silicon nitride layer is patterned (b). Then, a photoresist layer (second protection layer) is formed on an opposing second surface of the silicon substrate. The photoresist layer is patterned, such that the pattern of the photoresist layer is symmetric to the pattern of the silicon nitride layer (c).

Silicon nanoparticles are aligned on the first surface of the silicon substrate, using an LB method, so as to form a continuous monolayer of the silicon nanoparticles. The silicon nanoparticles are separated from each other by plasma etching (d). Then, Ag is deposited between the silicon nanoparticles by PVD, to form an Ag layer (e). The patterned photoresist layer is then removed (f). In this regard, the Ag layer and the silicon nanoparticles present on the photoresist layer are removed, when the patterned photoresist layer is removed.

Then, the remaining silicon nanoparticles are removed using ultrasonic waves, to form a patterned Ag mask layer including regularly arranged nanoholes, on a portion of the silicon substrate where the photoresist layer was not formed (g). Then, a portion of the silicon substrate, on which the Ag mask layer is formed, is selectively etched by metal assisted etching. The Ag mask layer is removed, such that silicon nanorods are formed on portions of the first surface of the silicon substrate (h). Then, a Pd electrode layer is deposited on the silicon substrate, so as to fill depressions formed between the silicon nanorods (i).

The exposed second surface of the silicon substrate is etched with a KOH solution, to form a freestanding Pd electrode having a first surface that includes nanorods (j). Then, a proton-conducting solid oxide electrolyte layer and another electrode are additionally formed on the second surface of the Pd electrode, thereby forming an MEA.

In the methods of manufacturing a proton conductive solid oxide fuel cell, the proton-conducting solid oxide electrolyte layer, the cathode, the anode, and the protection layer may be each independently formed, by using at least one method selected from the group consisting of sputtering, chemical vapor deposition (CVD), PVD, atomic layer deposition (ALD), plating, pulse laser deposition, molecular beam epitaxy, and vacuum deposition. However, the formation method is not limited thereto. For example, the formation method may be any method that is used for forming a layer in the art. The plating may be electro-plating or electrode-free plating.

A proton conductive solid oxide fuel cell, according to an embodiment of the present invention, may be manufactured using any one of the methods described above. The proton conductive solid oxide fuel cell has a three-dimensional, nano-scale, uneven structure. Due to the inclusion of the three-dimensional structure, the height of the fuel cell may be reduced, as compared to conventional cases. Thus, an electron pathway and resistance are reduced. In addition, since the fuel cell may be manufactured by PVD, without the use of expensive exposure equipment, such as a stepper, the manufacturing process is simplified and the manufacture costs are reduced.

A proton conductive solid oxide fuel cell, according to another exemplary embodiment of the present invention, includes an MEA including an anode, a cathode, and a proton-conducting solid oxide electrolyte membrane interposed therebetween. The MEA has an uneven (wrinkled) overall structure, including a protrusions and depressions. The area density of the MEA is represented by Equation 1 and may be greater than 1:

Area density=reaction area/apparent area, [Equation 1]

wherein the reaction area is a total area of the membrane electrode assembly available for reaction, and the apparent area includes only a two-dimensional area covered by the reaction area. For example, the area density may be in a range of about 1.1 to about 20, about 1.5 to about 20, or about 1.7 to about 20.

With regard to the proton conductive solid oxide fuel cell, the apparent area of the MEA may be equal to or greater than 0.1 cm². For example, the apparent area may be in a range of about 0.1 to about 1000 cm², or about 1 to about 100 cm².

In the proton conductive solid oxide fuel cell, the protrusions and/or the depressions may be tapered. Due to the tapered shape of the protrusions and/or the depressions, the MEA may not have a smooth vertical surface in a thickness direction thereof. Thus, a process that has poor conformality with respect to walls, such as PVD or CVD, may be used. These processes are inexpensive, due to having a higher process rate than a process that has good conformality with respect to walls, such as ALD. In the case of PVD, once a target is formed, a material with a desired composition is obtained. Thus, PVD is simpler than CVD, which requires development of a precursor of a target electrolyte.

The angle of the tapered structure is an angle between a normal line of a surface of the substrate and a tangent line of the tapered structure. For example, the angle of the tapered structure may be in a range of about 10° to about 80°, about 25° to about 75°, or about 30° to about 60°.

In the MEA, the protrusions and/or depressions may be wedge-shaped in cross-section. A distance between the summits of adjacent protrusions may be 2 μm or less. For example, the distance may be in a range of about 200 to about 1900 nm, or about 250 to about 1300 nm. In addition, a distance between a summit of a protrusion and the bottom of a depression nearest to the summit, in a thickness direction of the MEA, may be 1 μm or less. For example, the distance between the summit and the bottom may be in a range of about 100 to about 900 nm, or about 250 to about 750 nm.

The anode and the cathode each may have a layered structure or a porous structure, through which oxygen and/or hydrogen ions may pass. The anode and the cathode may each independently include at least one material selected from the group consisting of metal, such as platinum (Pt), nickel (Ni), palladium (Pd), or silver (Ag); a perovskite doped with one or more materials selected from lanthanium, strontium, barium, and cobalt; an oxygen ion conductor, such as a ceria doped with at least one material selected from the group consisting of zirconia, gadolinium, samarium, lanthanium, ytterbium, and neodymium, each of which doped with yttrium or scandium; a hydrogen ion-conducting metal, such as palladium (Pd), Pd—Ag alloy, or vanadium (V); zeolite; lanthanium or calcium-doped strontium manganese oxide (LSM); and lanthanium strontium cobalt iron oxide (LSCF). However, the materials for forming the anode and the cathode are not limited thereto. For example, the materials for forming the anode and the cathode may each be any material that is used to form an anode or a cathode in the art.

The anode and the cathode each may have a thickness of 10 μm or less. For example, the anode and the cathode each may have a thickness in a range of about 5 nm to about 5 μm, about 5 nm to about 2.5 μm, about 5 nm to about 500 nm, or about 5 nm to about 200 nm.

In the proton conductive solid oxide fuel cell, a catalyst may be further disposed on surfaces of the anode and the cathode of the MEA. The catalyst may be sub-micron particles. For example, the catalyst may be nanoparticles.

The catalyst may include at least one material selected from the group consisting of metallic catalysts such as platinum, ruthenium, nickel, palladium, gold, or silver; oxides such as La₁₋ₓSrₓMnO₃(0<x<1), La₁₋ₓSrₓCoO₃(0<x<1), or La₁₋ₓSrₓCo_{y}Fe_{1-y}O₃(0<x<1, <y<1); and alloys thereof. However, the catalyst is not limited thereto. For example, the catalyst may be any catalyst that is used in the art.

In the proton conductive solid oxide fuel cell, the solid oxide electrolyte membrane may include at least one selected from the group consisting of a proton-conductive solid oxide and an oxygen ion and proton-conductive solid oxide. For example, the proton-conductive solid oxide electrolyte membrane may be a doped fluorite, such as doped yttrium oxide or a doped perovskite.

For example, the proton-conductive solid oxide may include at least one selected from the group consisting of hydrogen ion-substituted zeolite; β-alumina; and a bivalent or trivalent cation-doped barium zirconate, a bivalent or trivalent cation-doped barium cerate, a bivalent or trivalent cation-doped strontium cerate, or a bivalent or trivalent cation-doped strontium zirconate.

For example, the oxygen ion and proton-conductive solid oxide may include at least one selected from the group consisting of BaZrO₃, BaCeO₃, SrZrO₃, or SrCeO₃, each of which doped with a trivalent element such as yttrium (Y) or ytterbium (Yb); and Ba₂In₂O₅ doped with at least one cation selected from the group consisting of vanadium, niobium, tantalum, molybdenum, and tungsten.

A thickness of the proton-conductive solid oxide electrolyte layer may be less than 1 μm. For example, the thickness of the proton-conductive solid oxide electrolyte layer may be in a range of about 5 nm to about 1 μm, about 5 nm to about 500 nm, or about 5 nm to about 200 nm.

The present invention will be described in further detail with reference to the following examples. These examples are for illustrative purposes only and are not intended to limit the scope of the present invention.

### Example 1

### Manufacture of Nanotube-Type Fuel Cell

Silicon nanoparticles were aligned at a high density, on a first surface of a silicon substrate, using an LB method, to form a continuous monolayer, in which neighboring silicon nanoparticles contact each other (see FIG. 4A). Then, the silicon nanoparticles were separated from each other, by plasma etching (see FIG. 4B). The plasma etching was performed by applying plasma for about 4 minutes, with an oxygen flow rate of 10 SCCM and a CHF₃ gas flow rate of 85 SCCM, in an etching chamber. A base pressure of the chamber was maintained at 0.8 mTorr. Plasma was generated by setting a plasma generation device to have a DC bias of 530 V and a maximum output of 1,600 W. Particle diameters of the etched silicon nanoparticles were about 300 nm.

Then, Ag was deposited between the silicon nanoparticles by PVD, to form an Ag layer. Then, the silicon nanoparticles were removed using ultrasonic waves, to form an Ag mask layer, including regularly arranged nanoholes, on the silicon substrate (see FIG. 4C). Then, the resultant structure was immersed in a solution including hydrogen peroxide and fluoric acid (a mixture ratio of H₂O₂: HF: H₂O was 5:10:35), so as to selectively etch a portion of the silicon substrate on which the Ag mask layer was formed, in a thickness direction of the silicon substrate.

Then, the resultant structure was immersed in aquaregia (a solution including hydrochloric acid and nitric acid, in a mixture ratio of 3:1), to remove the Ag mask layer, so that silicon nanorods were formed on the first surface of the substrate (see FIG. 4D). Then, a proton-conductive solid oxide electrolyte thin film (BYZ: Y: BaZrO₃), having a thickness of about 130 nm, was deposited on the first surface including the silicon nanorods, and a silicon nitride layer was formed on an opposing second surface of the silicon substrate.

Then, a portion of the silicon nitride layer was etched by lithography, to expose a portion of the second surface of the silicon substrate. Then, the exposed second surface of the silicon substrate was partially etched with a KOH solution. Then, the partly etched second surface was completely etched using XeF₂, thereby forming a freestanding proton-conductive solid oxide electrolyte thin film (BYZ: Y:BaZrO₃) having an uneven structure. Then, a Pt cathode having a thickness of about 80 nm, and a Pt anode having a thickness of about 80 nm, were respectively formed on opposing surfaces of the electrolyte thin film, thereby manufacturing an MEA.

### Example 2

### Manufacture of Nanowedge-Type Fuel Cell

Silicon nanoparticles were aligned at a high density on a first surface of a silicon substrate, using an LB method, to form a continuous monolayer of silicon nanoparticles. Then, the silicon nanoparticles were separated from each other by plasma etching. The plasma etching was performed by applying plasma for 3 to 5 minutes, with an oxygen flow rate of 10 SCCM and a CHF₃ gas flow rate of 85 SCCM, into an etching chamber. A base pressure of the chamber was maintained at 0.8 mTorr. Plasma was generated by setting a plasma generation device to have a DC bias of 530 V and a maximum output of 1,600 W. Particle diameters of the etched silicon nanoparticles were about 300 nm.

Al was deposited between the silicon nanoparticles by PVD, to form an Al layer. Then, the silicon nanoparticles were removed using ultrasonic waves, to form an Ag mask layer, including regularly arranged nanoholes, on the silicon substrate. Then, portions of the silicon substrate exposed through the nanoholes were selectively either isotropically or anisotropically, or both isotropically and anisotropically, etched, in a thickness direction of the silicon substrate. The Al mask layer was removed, so that the first surface of the silicon substrate had tapered protrusions and depressions (see FIG. 5A).

Silicon nitride layers were formed both on the uneven surface of the silicon substrate and on a surface of the silicon substrate opposite to the uneven surface, and then a portion of the silicon nitride layer formed on the second surface was removed to expose a portion of the second surface of the silicon substrate. Then, the exposed second surface of the silicon substrate was etched with a KOH solution, to form a silicon nitride freestanding thin film (see FIG. 5B).

A proton-conducting solid oxide electrolyte layer (BYZ: Y:BaZrO₃) having a thickness of about 130 nm was formed on the freestanding silicon nitride layer, and then the silicon nitride layer was removed, to form a freestanding proton-conducting solid oxide electrolyte thin film (BYZ: Y:BaZrO₃) having tapered protrusions and depressions. Then, a Pt cathode having a thickness of about 80 nm, and a Pt anode having a thickness of about 80 nm, were respectively formed on opposing surfaces of the electrolyte layer, thereby manufacturing an MEA (see FIG. 5C).

### Example 3

### Manufacture of Fuel Cell Including Nanorod-Type Electrode

A silicon nitride layer was formed on a first surface of a silicon substrate. Then, the silicon nitride layer was patterned. A photoresist layer was formed on an opposing second surface of the silicon substrate. The photoresist layer was patterned, such that the pattern of the photoresist layer was symmetric to the pattern of the silicon nitride layer.

A continuous monolayer of silicon nanoparticles was formed on the first surface of the silicon substrate, on which the patterned photoresist layer was formed, using an LB method. The silicon nanoparticles were separated from each other by plasma etching. The plasma etching was performed by applying plasma for 3 to 5 minutes, with an oxygen flow rate of 10 SCCM and a CHF₃ gas flow rate of 85 SCCM, into an etching chamber. A base pressure of the chamber was maintained at 0.8 mTorr. Plasma was generated by setting a plasma generation device to a DC bias of 530 V and a maximum output of 1,600 W. Particle diameters of the etched silicon nanoparticles were about 250 nm.

Ag was deposited between the silicon nanoparticles by PVD, to form an Ag layer. Then, the patterned photoresist layer was removed. Then, the remaining silicon nanoparticles were removed using ultrasonic waves, to form a patterned Ag mask layer, including regularly arranged nanoholes, on the silicon substrate. A portion of the silicon substrate, on which the Ag mask layer was formed, was selectively etched in a thickness direction of the silicon substrate, by metal assisted etching. The Ag mask layer was then removed, so that the first surface of the silicon substrate had exposed silicon nanorods (see FIG. 6).

A Pd electrode layer, filling spaces between the silicon nanorods, was deposited on the silicon substrate. Then, the exposed second surface of the silicon substrate was etched with a KOH solution, to form a freestanding Pd electrode thin film, having a first surface including nanorod-shaped protrusions and a thickness of about 80 nm. Then, a proton-conductive solid oxide electrolyte layer (BYZ: Y:BaZrO₃) having a thickness of about 130 nm and a Pt electrode having a thickness of about 80 nm were additionally formed on an opposing second surface of the Pd electrode, thereby manufacturing an MEA. Pd is a mixed conductor of hydrogen ions and electrons.

### Comparative Example 1

An MEA was manufactured in the same manner as in Example 2, except that the proton-conductive solid oxide electrolyte layer, the cathode, and the anode did not have the uneven structure.

### Evaluation Example 1

### Fuel Cell Performance Test

An area density of an MEA manufactured according to Example 2 was in the range of about 1.7 to about 1.8, and an area density of an MEA manufactured according to Comparative Example 1 was 1.

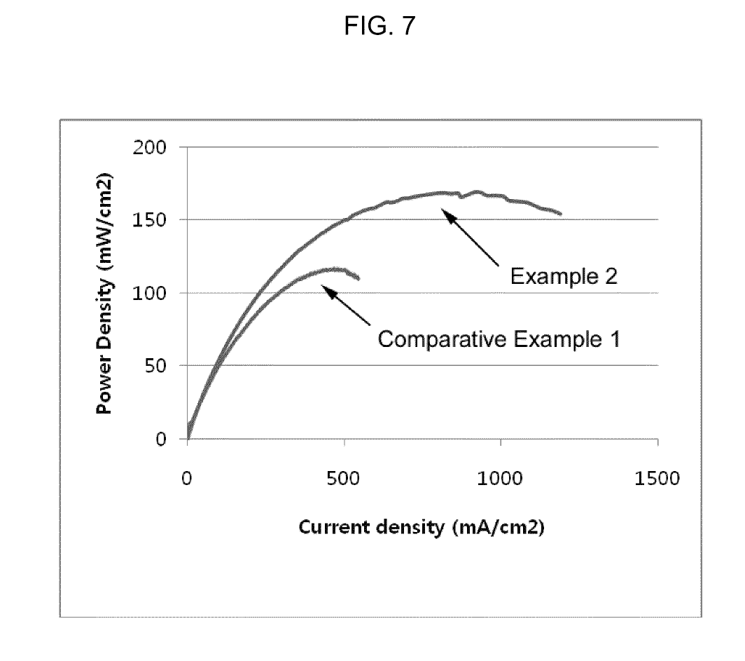

Maximum output densities of the MEAs manufactured according to Example 2 and Comparative Example 1 were measured. Each of the MEAs manufactured according to Example 2 and Comparative Example 1 was installed on a test station and then connected to a potentiometer (Gamry FAS2 Femtostat). The MEAs were heated to a temperature of 450° C., and I-V (current-voltage) performances thereof were measured. The results are shown in Table 1 and FIG. 7.

TABLE 1

| | Maximum Output Power |
|---|---|
| | Density [mW/cm2] |
| Example 2 | 170 |
| Comparative | 116 |
| Example 1 | |

As shown in Table 1, when an area density was increased 1.8 times, a maximum output density of a fuel cell including the MEA of Example 2 was increased by 45%, as compared to that of a fuel cell including the MEA of Comparative Example 2. Accordingly, as compared to a conventional method (Nano letters, 8(8), pp. 2289-2292, 2008), where an area density is increased fivefold, but a maximum output density is increased by only 50%, substantially improved performance may be obtained.

As described above, according to the one or more of the above exemplary embodiments of the present invention, a 3-dimensional nano-scale uneven structure may be easily formed by using nanoparticles, and a proton conductive solid oxide fuel cell having a high output density may be obtained by including such a structure. In addition, since a fuel cell having a nano-scale structure may be manufactured without the use of expensive exposure equipment, such as a stepper, the manufacturing costs may also be reduced.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A method of manufacturing a proton conductive solid oxide fuel cell, the method comprising:
forming a metallic mask layer having nanoholes, on a first surface of a substrate;
etching a first surface of the substrate using the metallic mask layer, such that the first surface of the substrate has an uneven structure;
depositing a first membrane electrode assembly (MEA) member or a first protection layer on the first surface of the substrate; and
etching an opposing second surface of the substrate.

2. The method of claim 1, wherein the forming of the metallic mask layer comprises:
applying nanoparticles to the first surface of the substrate;
depositing a metal layer on the first surface of the substrate, between the nanoparticles; and
removing the nanoparticles to form the metallic mask layer.

3. The method of claim 2, wherein the applying of the nanoparticles comprises:
forming a monolayer of the nanoparticles on the substrate; and
etching the monolayer to separate the nanoparticles.

4. The method of claim 1, wherein the etching of the first surface of the substrate comprises:
selectively etching the first surface of the substrate; and
removing the metallic mask layer.

5. The method of claim 4, wherein the selective etching of the first surface of the substrate comprises etching portions of the first surface that contact the metallic mask layer.

6. The method of claim 1, wherein the first surface of the substrate comprises regularly arranged nanorods that extend away from the substrate.

7. The method of claim 1, wherein the first MEA member is a proton-conductive solid oxide electrolyte.

8. The method of claim 1, wherein the etching of the second surface of the substrate comprises:
forming a second protection layer on the second surface of the substrate;
removing a portion of the second protection layer, to expose a portion the second surface of the substrate;
partially etching the exposed portion of the second surface of the substrate; and
completely etching the remaining exposed portion of second surface of the substrate, such that the first MEA member is freestanding and has an uneven structure.

9. The method of claim 8, wherein the uneven structure of the first MEA member comprises nanotubes that extend generally in a first direction.

10. The method of claim 9, wherein the first direction is perpendicular to a long axis of the first MEA member.

11. The method of claim 8, further comprising depositing second and third MEA members on the first MEA member.

12. The method of claim 1, further comprising forming a second protection layer on the second surface of the substrate, prior to the etching of the second surface of the substrate.

13. The method of claim 12, wherein, when the depositing comprises depositing the first protection layer, the etching of the second surface of the substrate comprises:
removing a portion of the second protection layer, to expose a portion of the second surface of the substrate; and
etching the exposed portion of the second surface of the substrate, such that the first protection layer is a freestanding thin film.

14. The method of claim 4, wherein, during the selective etching of the first surface of the substrate, portions of the first surface that face the nanoholes are not etched.

15. The method of claim 12, wherein the etching of the second surface of the substrate comprises:
etching the second surface of the substrate, such that the first protection layer is a freestanding thin film having an uneven structure;
depositing the first MEA member on the first protection layer; and
removing the first protection layer from the first MEA member, such that the first MEA member is a free standing thin film having an uneven structure.

16. The method of claim 15, further comprising depositing second and third MEA members on the first MEA member.

17. The method of claim 1, wherein the first MEA member is deposited such that the first MEA member fills protrusions and depressions formed in the first surface of the substrate.

18. The method of claim 2, further comprising, forming a patterned photoresist layer on the first surface of the substrate, and forming a patterned protection layer on the second surface of the substrate, prior to the applying of the nanoparticles.

19. The method of claim 2, further comprising, before or during the removing of the nanoparticles to form the metallic mask layer, removing a patterned photoresist layer formed between portions of the metallic mask layer and the substrate.

20. The method of claim 1, wherein the first surface of the substrate includes portions having the uneven structure and portions that are generally flat.

21. The method of claim 1, wherein the etching of the second surface of the substrate comprises completely removing the substrate, such that the MEA member is a freestanding thin film having a wrinkled structure.

22. The method of claim 21, wherein second and third MEA members are deposited on opposing surfaces of the first MEA member.

23. A proton conductive solid oxide fuel cell manufactured according to the method of claim 1.

24. A membrane electrode assembly (MEA) of a proton-conductive solid oxide fuel cell, comprising:
an anode;
a cathode; and
a proton-conductive solid oxide electrolyte membrane interposed between the anode and the cathode,
wherein the MEA has protrusions and depressions, such that the MEA has a wrinkled structure.

25. The proton conductive solid oxide fuel cell of claim 24, wherein an area density of the MEA is represented by Equation 1 and is greater than 1:
Area density=reaction area/apparent area, [Equation 1]
wherein the reaction area is a total area of the MEA available for a reaction, and the apparent area comprises only a two-dimensional area covered by the reaction area.

26. The proton conductive solid oxide fuel cell of claim 24, wherein an apparent area of the MEA is at least 0.1 cm².

27. The proton conductive solid oxide fuel cell of claim 24, wherein the protrusions and the depressions are tapered.

28. The proton conductive solid oxide fuel cell of claim 24, wherein at least one of the protrusions and depressions is wedge-shaped in cross-section.

29. The proton conductive solid oxide fuel cell of claim 24, wherein the distance between the summits of adjacent protrusions is less than 2 μm.

30. The proton conductive solid oxide fuel cell of claim 24, wherein the distance between the summit of one of the protrusions and the bottom of an adjacent one of the depressions is less than 2 μm.

31. The proton conductive solid oxide fuel cell of claim 24, wherein each of the anode and the cathode comprises at least one material selected from the group consisting of: platinum (Pt); nickel (Ni); palladium (Pd); silver (Ag); a perovskite doped with one or more materials selected from lanthanium, strontium, barium, and cobalt; yttrium, and scandium-doped zirconia; ceria doped with at least one material selected from the group consisting of gadolinium, samarium, lanthanium, ytterbium, and neodymium; at least one hydrogen ion-conducting metal selected from the group consisting of palladium (Pd), a Pd—Ag alloy, and vanadium (V); zeolite; a lanthanium or calcium-doped strontium manganese oxide (LSM); and lanthanium strontium cobalt iron oxide (LSCF).

32. The proton conductive solid oxide fuel cell of claim 24, further comprising a catalyst disposed on surfaces of the anode and the cathode.

33. The proton conductive solid oxide fuel cell of claim 32, wherein the catalyst comprises at least one selected from the group consisting of platinum, ruthenium, nickel, palladium, gold, silver; La₁₋ₓSrₓMnO₃(0<x<1), La₁₋ₓSrₓCoO₃(0<x<1), La₁₋ₓSrₓCo_{y}Fe_{1-y}O₃(0<x<1, 0<y<1), and a alloy thereof.
